(19) United States
(12) Patent Application Publication
(10) Pub. No.: US 2020/0409765 A1
(43) Pub. Date: Dec. 31, 2020

(54) SOFTWARE PORTFOLIO MANAGEMENT

(71) Applicant: Raytheon Company, Waltham, MA (US)

(72) Inventors: Rachel Z. Almond, Tucson, AZ (US); Ryan Lindorff, Tucson, AZ (US); John Montgomery Herod, Tucson, AZ (US)

(21) Appl. No.: 16/451,935

(22) Filed: Jun. 25, 2019

(51) Int. Cl. G06F 9/50; G06F 11/36; G06F 8/77; G06F 8/71

(52) U.S. Cl. CPC G06F 9/5055; G06F 8/71; G06F 8/77; G06F 11/3616

(57) ABSTRACT

A system determines future resource allocation for a software application in a software portfolio. The system identifies the users of the software application, and receives from the users data relating to usage of the software application by the users. Using the data, the system determines the value of the software application. The system then automatically assigns resources to the software application when the value of the software application exceeds a threshold, and removes the software application from the software portfolio when the value of the software application falls below the threshold.

### TECHNICAL FIELD

The present disclosure relates to software portfolio management.

### BACKGROUND

After software applications are placed into production for use, it is not always clear when one or more of those applications should be retired (i.e, removed from the production environment), or when more or any resources should be put into one or more of those applications based on the value that those applications have to a business.

Currently, it is too difficult to make retirement decisions for software applications. Current systems only look at reports of usage each month for software applications, and then these systems try to determine if those software applications provide value to the business based only on those usage reports. Such a method is difficult to implement because it is not known if the value of the usage on which decisions are based is accurate and trustworthy. Moreover, each application is different. That is, a low use application could still be very valuable to the business. Further, prior systems focus on revenue-generating activities, and are designed to determine the cost of any downtime. That is, how much revenue will be lost for each minute of downtime? Other prior systems focus on revenue maximization, rather than cost avoidance. Consequently, in view of these prior systems, a standardized method that is more accurate and trustworthy would be beneficial to the business community.

### BRIEF DESCRIPTION OF THE DRAWINGS

FIG. 1 is an example of a chart that compares the values of different software applications.

FIGS. 2A and 2B are a block diagram illustrating operations and features of an example embodiment to determine the value of a software application and/or a software portfolio.

FIGS. 3A and 3B are another block diagram illustrating operations and features of another example embodiment to determine the value of a software application and/or a software portfolio.

FIG. 4 is a block diagram of a computer system upon which one or more embodiments of the present disclosure can execute.

### DETAILED DESCRIPTION

In the following description, for purposes of explanation, numerous specific details are set forth in order to provide a thorough understanding of the various aspects of different embodiments of the present invention. It will be evident, however, to one skilled in the art that the present invention may be practiced without all the specific details and/or with variations, permutations, and combinations of the various features and elements described herein.

In response to the issue described above of when or whether to put additional resources into a software application and/or software portfolio, an embodiment of the present disclosure determines the value of software applications to a business and allows resource managers to easily determine where to focus on support of software applications and where to focus on removal or retirement of software applications. This leads to better returns on investment on applications in the environment and reduces unnecessary costs. An embodiment therefore permits one to identify trends and to track when a software application may be approaching the point where it is no longer worthwhile to put additional resources into that software application. An embodiment answers the question “How do we save the most time, while spending the least amount of money?”

An embodiment therefore makes it possible to quantify the value of a software application, and consequently whether to put additional resources into the software application. Using prior processes, it was impossible to quantify the dollar amount an application was returning to a business and/or costing the business. However, with one or more embodiments disclosed herein, it is possible to quantify such a dollar amount. An embodiment is highly accurate and entails only moderate effort, whereas prior systems were not very accurate and invested only a minimum effort (which resulted in rather low returns). An embodiment is a tool that derives value from actual time savings as reported by the users at a standard hourly pay-rate, factoring in the costs associated with maintenance of applications and any other savings on an application-by-application basis. Using an embodiment of this disclosure, one study showed a 23% increase in software portfolio value, without a substantial change in costs, and identified a valuable low-usage software application that would have been mistakenly selected for retirement using a previous method.

At a high level, an embodiment determines the value of a software application by subtracting the costs associated with the software application from the cost avoidance associated with the software application. This provides a standard way to reliably and consistently determine software applications that should be retired as well as provides a value for retained applications. To determine the cost avoidance, surveys are sent to and completed by the users of the software application. Additional cost avoidance can be for example recertification costs associated with the software application and inventory costs. Costs further can include software change requests and fixed costs associated with the software application such as power, administration, servers, maintenance, compliance, licensing, software vendor, and cooling costs.

As noted above, in an embodiment, users of a software application are surveyed to determine the cost avoidance per user associated with the software application. A 12-month rolling average of users is then used to determine the cost avoidance of the application. Then, savings from a deliverable provided after an application has been deployed are added (which includes savings estimates that are close to the actual savings), and fixed costs and change requests (CR) for revised and/or additional software functionality are subtracted.

This process can be represented in the following form:

Average Number of Users and Weeks×Hours Saved/User/Week=Total Hours Saved

Total Hours Saved×Hourly Rate of Users=Labor Avoidance Cost

Labor Avoidance Cost+Other Cost Avoidance=Total Cost Avoidance

Total Cost Avoidance−(CR and Fixed Costs)=Value of Software Application

For example, if the average number of users is 59.08, the relevant number of weeks is 52, the hours saved per week is 2, and the hourly rate of the users is $100, the following indicates that the value of the software application is $882,317.00.

59.08 Ave. Users×52 weeks×2 hours saved/user/week=6144.32 Total Hours Saved

6144.32 Total Hours Saved×$100 Hourly Rate=$614,432 Labor Cost Avoidance

$614,432 Labor Cost Avoidance+$300,000 (recertification/inventory)=$914,467

$914,467 Total Cost Avoidance−CR/Fixed Costa=$882,317 Value

That is, a particular use of a particular software application saved a company, that is the company avoided a cost of, a total of almost $900,000 in a year.

It is noted that some applications have a very high usage, whereas others have a very low usage. Because of this potential dichotomy, high or low usage applications can have a slightly different method of calculation. For example, for low usage applications, a “user” may be anyone who uses the application any number of times in a given month. For high usage applications, a “user” may be anyone who uses the application five or more times in a given month.

In an embodiment, surveys are conducted multiple times. For example, if a survey is conducted three times, a survey may be taken one year after an application is implemented, every twelve months, and if or when the value of an application (as calculated per the process outlined above) drops below a threshold (such as a $0 value). The survey can be very simple and straight forward, consisting of only a single question such as “How much time does the software application save you in an average week?”

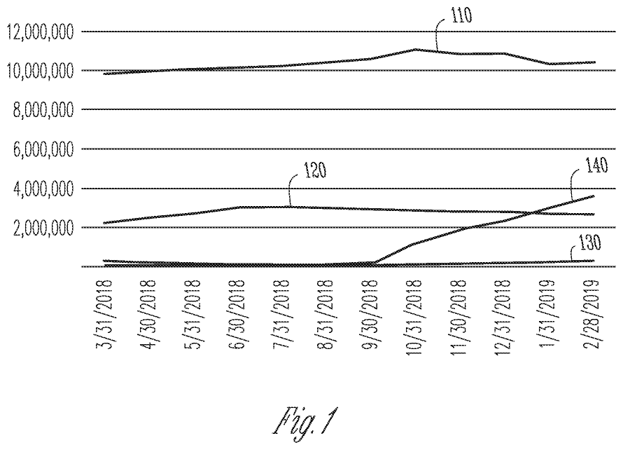

Reports can be generated and used to track trends in each application's value over time. For example, FIG. 1 illustrates the value of four software applications over a 52-week time period. Referring to FIG. 1, Application 110 has a consistently high value to the business of over $10 million, Application 120 has a consistent value of about $3 million, and Application 130 has a low value of close to $0. FIG. 1 further illustrates that Application 140 began the one-year time period with a value close to $0, but then ended the one-year time period with a value of around $4 million. From this, it can be determined when an application is nearing the end of its lifetime. In this example, Application 110 almost certainly should be kept and maintained, and Application 120 should probably be kept and maintained. In contrast, Application 130, with a consistently low value of $0, should almost certainly be retired. Interestingly, Application 140, even though it had a low value for much of the one-year time period, showed an increased value of almost $4 million dollars towards the end of the time-period, and should probably be maintained. After this analysis for this one-year time period, another survey can be taken to confirm which applications have value and which applications do not have value.

Consequently, one or more embodiments allow one to confidently make retirement decisions for software applications. Also, application owners will be incentivized to encourage teams to use their application. This will increase the value of the applications. And overall application portfolio value will be maximized. Additionally, some applications will be retired, and fewer applications will result in greater bandwidth for developing new applications and also for supporting existing applications.

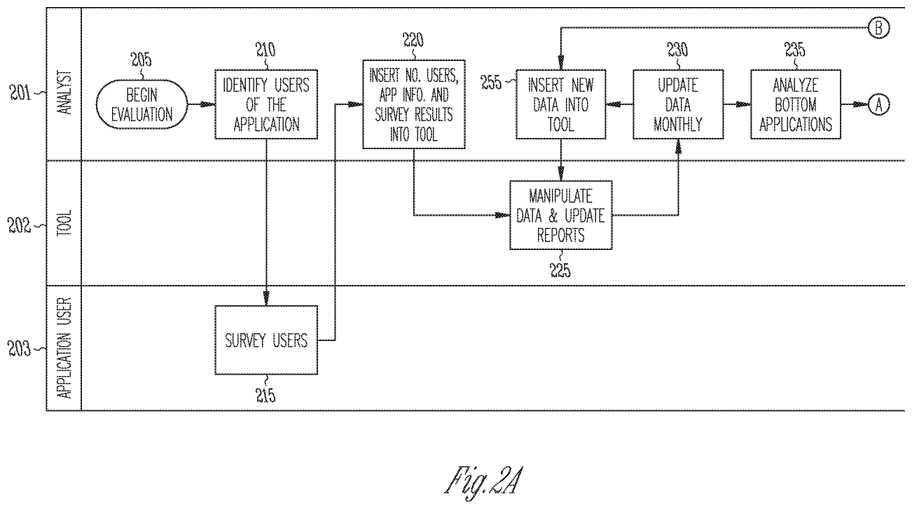

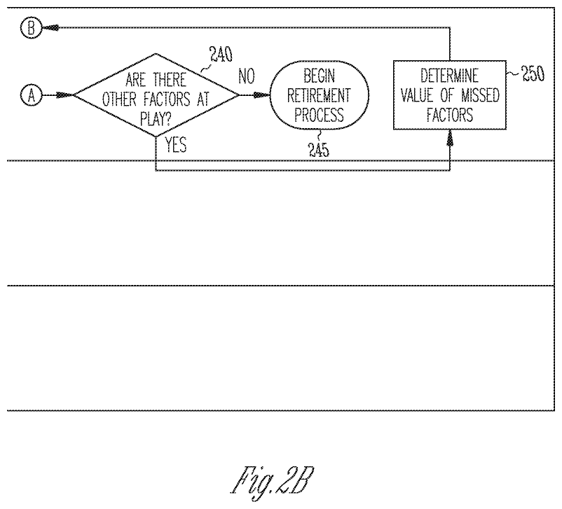

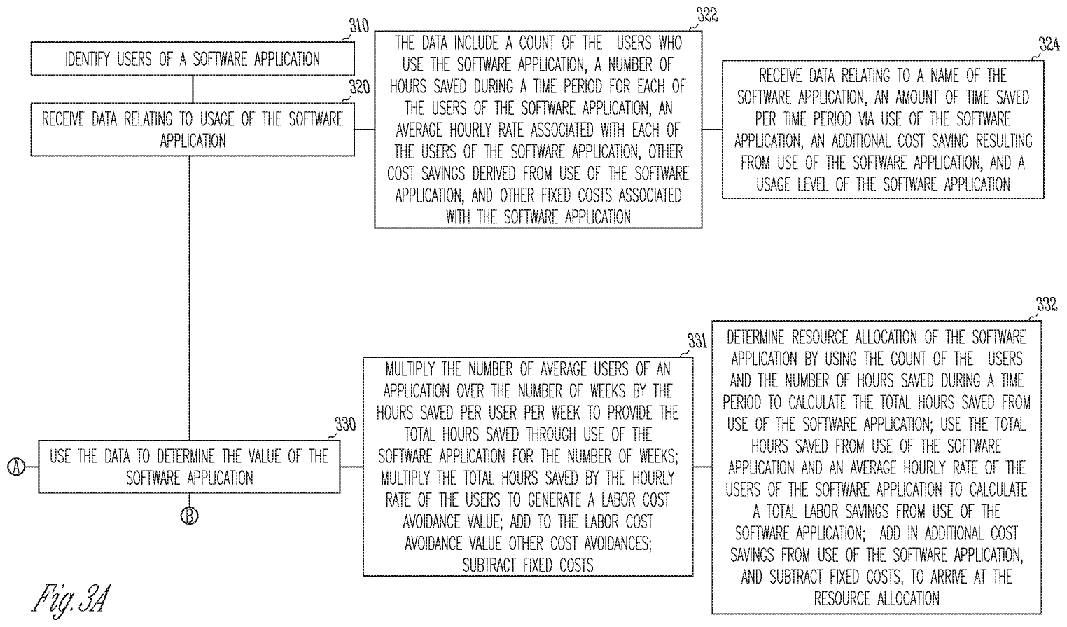

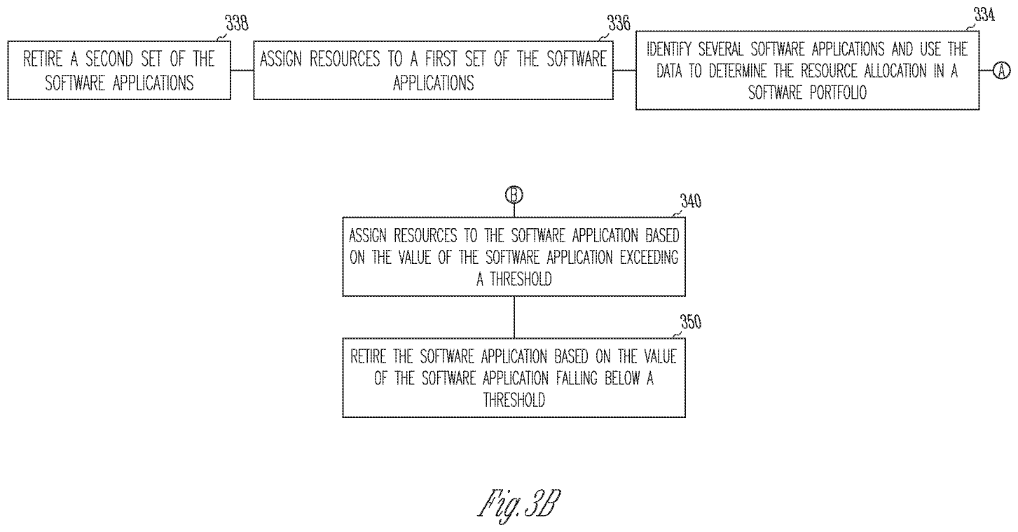

FIGS. 2A, 2B, 3A, and 3B are block diagrams illustrating operations and features of an example embodiment of a system and method to determine the value of a software portfolio. FIGS. 2A, 2B, 3A, and 3B include process blocks 205-255 and 310-352. Though arranged substantially serially in the example of FIGS. 2A, 2B, 3A, and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring first now to FIGS. 2A and 2B, an embodiment includes an analyst section 201, a tool section 202, and an application user section 203. The system begins processing at 205. As indicated at 210, users are surveyed to determine the number of users who use the software application. While in the embodiment of FIGS. 2A and 2B the users are surveyed, in other embodiments other methods could be used such as checking a database of users and/or checking a logon log for the software application.

At 220, the required data are added to the system. These data can include the average number of users of the software application, the aggregated number of weeks the software application is used by all users, the total hours saved per user of the software application per week, the hourly rate of the users, other cost avoidances such as recertification and inventory costs, and other fixed costs.

At 225, the data are manipulated. Specifically, the number of average users of an application over the number of weeks (normally based on 52 weeks of usage) is multiplied by the hours saved per user per week to provide the total hours saved through use of the software application for the number of weeks. The total hours saved are multiplied by the hourly [labor] rate of the users to generate a labor cost avoidance value. To the labor cost avoidance value other cost avoidances are added, and CR and fixed costs are subtracted to come up with the value of the software application.

Further, at operation 225, pertinent reports are updated. As indicated at 230, these reports can be updated and regenerated on a monthly basis. These reports can include charts that illustrate the value of all software applications, only the top-valued applications, or only the bottom-valued applications. An example of such a chart is illustrated in FIG. 1, which was discussed above. Regarding the bottom applications, that is, the software applications for which retirement should be considered, at 235, these bottom applications are analyzed to determine if indeed they should be retired. Such analysis can include a simple comparison to a threshold value, and if the value of the software application falls below that threshold value, then the software application should definitely be considered for retirement. In this retirement decision making process, at 240, there is a consideration of whether other factors are at play. If there are no other factors at play, then the retirement process for that software application is begun at 245. If there are other factors at play, then the value of those missed other factors are determined at 250, and these new data are added to the system at operation 255, and these new data are processed at operation 225. Examples of missed factors may be previously unidentified hardware savings, licensing savings, and/or risk mitigation.

Referring now to FIGS. 3A and 3B, which illustrates another example embodiment of a process and system to determine the value of a software portfolio, at 310, the users of a software application are identified. As was indicated in connection with FIGS. 2A and 2B, one means of doing this identification is via a user survey.

At 320, the system receives from the users of the software application data relating to usage of the software application by the users. As indicated at 322, the data include a count of the users who use the software application, a number of hours saved during a time period for each of the users of the software application, an average hourly rate associated with each of the users of the software application, other cost savings derived from use of the software application, and other fixed costs associated with the software application. At 324, the identifying of the plurality of software applications in the software portfolio includes receiving data relating to a name of the software application, an amount of time saved per time period via use of the software application, an additional cost saving resulting from use of the software application, and a usage level of the software application.

At 330, the system uses the data to determine the value of the software application. As indicated above, in an embodiment, as indicated at 332, this involves multiplying the number of average users of an application over the number of weeks (normally based on 52 weeks of usage) by the hours saved per user per week to provide the total hours saved through use of the software application for the number of weeks. The total hours saved is then multiplied by the hourly [labor] rate of the users to generate a labor cost avoidance value. To the labor cost avoidance value other cost avoidances are added, and CR and fixed costs are subtracted to come up with the value of the software application. As indicated at 332, determining resource allocation of the software application includes using the count of the users who use the software application and the number of hours saved during a time period for each of the users of the software application to calculate the total hours saved from use of the software application, using the total hours saved from use of the software application and an average hourly rate of the users of the software application to calculate a total labor savings from use of the software application, adding in additional cost savings from use of the software application, and subtracting fixed costs, to arrive at the resource allocation. As indicated at 334, the system can identify several software applications in the software portfolio, and use the data to determine the resource allocation of the software portfolio. At 336, the system automatically assigns resources to a first set of the software applications in the software portfolio. At 338, the system automatically retires a second set of the software applications from the software portfolio.

At 340, the system automatically assigns resources to the software application in the software portfolio based on the value of the software application exceeding a threshold. Alternatively, personnel can consider the calculated value of the software application, and make a retirement decision based solely on that value, or make a retirement decision considering other factors in addition to the calculated value (although the calculated value may be the predominant factor).

At 350, the system automatically retires the software application in the software portfolio based on the value of the software application falling below a threshold. Alternatively, personnel can consider the calculated value of the software application, and make a retirement decision based solely on that value, or make a retirement decision considering other factors in addition to the calculated value (although the calculated value may be the predominant factor).

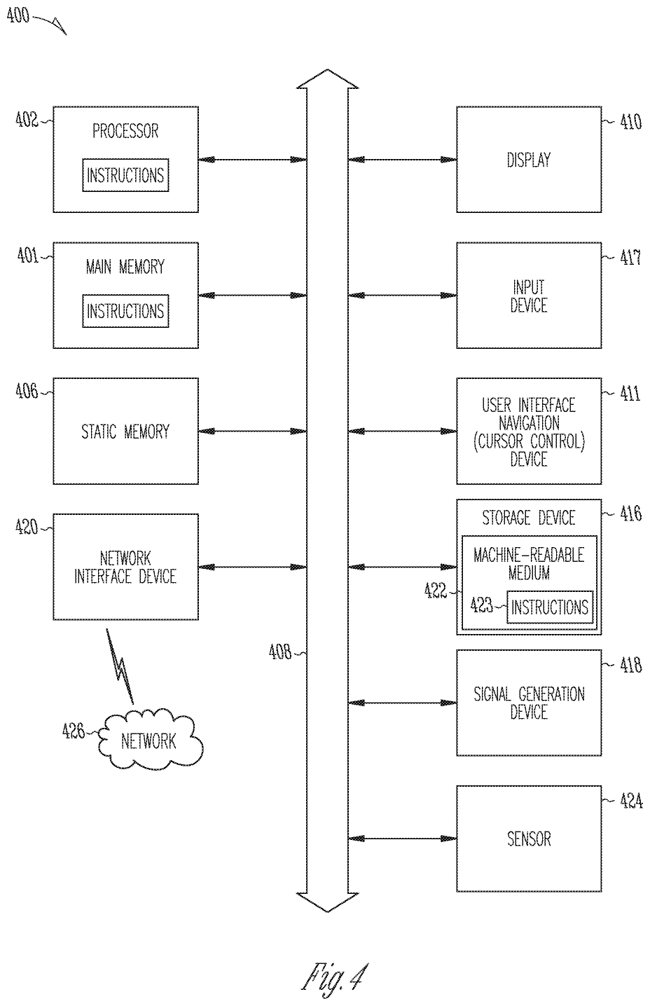

FIG. 4 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 401 and a static memory 406, which communicate with each other via a bus 408. The computer system 400 may further include a display unit 410, an alphanumeric input device 417 (e.g., a keyboard), and a user interface (UI) navigation device 411 (e.g., a mouse). In one embodiment, the display, input device and cursor control device are a touch screen display. The computer system 400 may additionally include a storage device 416 (e.g., drive unit), a signal generation device 418 (e.g., a speaker), a network interface device 420, and one or more sensors 421, such as a global positioning system sensor, compass, accelerometer, or other sensor.

The drive unit 416 includes a machine-readable medium 422 on which is stored one or more sets of instructions and data structures (e.g., software 423) embodying or utilized by any one or more of the methodologies or functions described herein. The software 423 may also reside, completely or at least partially, within the main memory 401 and/or within the processor 402 during execution thereof by the computer system 400, the main memory 401 and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 423 may further be transmitted or received over a communications network 426 using a transmission medium via the network interface device 420 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

1. A process to determine resource allocation for a software application in a software portfolio comprising:
identifying, using a computer processor, a plurality of users of the software application;
receiving from the plurality of users of the software application data relating to usage of the software application by the plurality of users, the data comprising a count of the users who use the software application, a number of hours saved during a time period for each of the users of the software application, an average hourly rate associated with each of the users of the software application, other cost savings derived from use of the software application, and other fixed costs associated with the software application;
using the data, determining a value of the software application in the software portfolio;
automatically assigning resources to the software application in the software portfolio based on the value of the software application exceeding a threshold; and
removing the software application from the software portfolio based on the value of the software application falling below the threshold.

2. The process of claim 1, wherein determining the value of the software application comprises using the count of the users who use the software application and the number of hours saved during a time period for each of the users of the software application to calculate the total hours saved from use of the software application; using the total hours saved from use of the software application and an average hourly rate of the users of the software application to calculate a total labor savings from use of the software application, adding in additional cost savings from use of the software application, and subtracting fixed costs, to arrive at the value.

3. The process of claim 1, comprising identifying a plurality of software applications in the software portfolio; and using the data for determining the value and the resource allocation of the software portfolio.

4. The process of claim 3, comprising using the computer processor to automatically assign resources to a first set of software applications and to automatically retire a second set of software applications.

5. The process of claim 3, wherein the identifying the plurality of software applications in the software portfolio comprises receiving into the computer processor data relating to a name of the software application, an amount of time saved per time period via use of the software application, an additional cost saving resulting from use of the software application, and a usage level of the software application.

6. A system to determine resource allocation for a software application in a software portfolio comprising:
a computer processor; and
a computer-readable medium coupled to the computer processor;
wherein the computer processor is operable for:
identifying a plurality of users of the software application;
receiving from the plurality of users of the software application data relating to usage of the software application by the plurality of users, the data comprising a count of the users who use the software application, a number of hours saved during a time period for each of the users of the software application, an average hourly rate associated with each of the users of the software application, other cost savings derived from use of the software application, and other fixed costs associated with the software application;
using the data, determining a value of the software application in the software portfolio;
automatically assigning resources to the software application in the software portfolio based on the value of the software application exceeding a threshold; and
removing the software application from the software portfolio based on the value of the software application falling below the threshold.

7. The system of claim 6, wherein determining the value of the software application comprises using the count of the users who use the software application and the number of hours saved during a time period for each of the users of the software application to calculate the total hours saved from use of the software application; using the total hours saved from use of the software application and an average hourly rate of the users of the software application to calculate a total labor savings from use of the software application, adding in additional cost savings from use of the software application, and subtracting fixed costs, to arrive at the value.

8. The system of claim 6, comprising identifying a plurality of software applications in the software portfolio; and using the data for determining the resource allocation of the software portfolio.

9. The system of claim 8, comprising automatically assigning resources to a first set of software applications and to automatically retire a second set of software applications.

10. The system of claim 8, wherein the identifying the plurality of software applications in the software portfolio comprises receiving into the computer processor data relating to a name of the software application, an amount of time saved per time period via use of the software application, an additional cost saving resulting from use of the software application, and a usage level of the software application.

11. A non-transitory computer readable medium comprising instructions that when executed by a processor execute a process to determine resource allocation for a software application in a software portfolio comprising:
identifying a plurality of users of the software application;
receiving from the plurality of users of the software application data relating to usage of the software application by the plurality of users, the data comprising a count of the users who use the software application, a number of hours saved during a time period for each of the users of the software application, an average hourly rate associated with each of the users of the software application, other cost savings derived from use of the software application, and other fixed costs associated with the software application;
using the data, determining the value of the software application in the software portfolio;
automatically assigning resources to the software application in the software portfolio based on the value of the software application exceeding a threshold; and
removing the software application from the software portfolio based on the value of the software application falling below the threshold.

12. The non-transitory computer readable medium claim 11, wherein determining the value of the software application comprises using the count of the users who use the software application and the number of hours saved during a time period for each of the users of the software application to calculate the total hours saved from use of the software application; using the total hours saved from use of the software application and an average hourly rate of the users of the software application to calculate a total labor savings from use of the software application, adding in additional cost savings from use of the software application, and subtracting fixed costs, to arrive at the resource allocation.

13. The non-transitory computer readable medium of claim 11, comprising identifying a plurality of software applications in the software portfolio; and using the data for determining the resource allocation of the software portfolio.

14. The non-transitory computer readable medium of claim 13, comprising automatically assigning resources to a first set of software applications and to automatically retire a second set of software applications.

15. The non-transitory computer readable medium of claim 13, wherein the identifying the plurality of software applications in the software portfolio comprises receiving into the computer processor data relating to a name of the software application, an amount of time saved per time period via use of the software application, an additional cost saving resulting from use of the software application, and a usage level of the software application.
